(19) United States
(12) Patent Application Publication
(10) Pub. No.: US 2001/0006855 A1
(43) Pub. Date: Jul. 5, 2001

(54) ESD protecting device

(75) Inventor: Evald Koitsalu, Stockholm (SE)

Correspondence Address: Gerald T. Welch, Jenkens & Gilchrist, P.C., 3200 Fountain Place, 1445 Ross Avenue, Dallas, TX, 75202-2799, US

(73) Assignee: Telefonaktiebolaget LM Ericsson

(21) Appl. No.: 09/745,683

(22) Filed: Dec. 21, 2000

(30) Foreign Application Priority Data
Dec. 30, 1999 (SE) 9904862-1

(51) Int. Cl. H01R 4/66; H01R 13/648; H01R 13/53; H01R 29/00

(52) U.S. Cl. 439/188; 439/101; 439/108; 439/181; 439/630

(57) ABSTRACT

A memory card receptacle 20 comprising at least one contact 30 (37,38) for electrically contacting a memory card 18. The memory card receptacle 20 has at least one grounding contact member 36, for protecting electronic equipment 10 against electro static discharge (ESD), whereat each contact 30 (37,38) is in contact with said grounding contact member when there is no memory card 18 inserted in the memory card receptacle 20. A portable radio communication station having SIM chip card reader according to the invention is disclosed.

### TECHNICAL FIELD OF THE INVENTION

This invention relates to devices for protecting electronic equipment against electro static discharge (ESD).

### TECHNICAL BACKGROUND

Memory card is often used in different electronic equipment having a control unit. A memory card is a bearer of information that is readable by the control unit in said electronic equipment. A user can change the features of electronic equipment by changing the memory card to a new one containing different information. In portable transceivers like mobile stations for mobile radio telecommunication memory card is used containing subscriber and operator information. This card is called a SIM chip card (Subscriber Identification Module). An interface providing electrical connections between a SIM chip card and electronics internal to the portable transceiver is called SIM chip card reader. Once the SIM chip card is retained in the reader, sliding contacts of the reader are coupled to the SIM chip card contacts, allowing the portable transceiver access to the information stored within the SIM chip card. The electrical operation of the SIM chip card is described in International Standards Organisation (ISO) Document #7816-3: 1988 (E), Technical Committee ISO/TC 97, Information Processing Systems, May 15, 1988 (First Edition).

The developments have resulted in smaller electronic components and circuits internal to the portable transceiver that is working at lower and lower drive voltage. Said electronics and circuit becomes therefore more sensitive to ESD charges that could rice to many thousands Volt. The contacts of the reader could conduct said high charges to said electronics causing a lot of damage inside the transceiver.

### DESCRIPTION OF THE INVENTION

One object of this invention is to provide a design that solves the problem to protect electronic equipment having a memory card receptacle against ESD damage.

This object is achieved by providing said memory card receptacle with at least one grounding contact member.

A more detailed description of the invention is that the memory card receptacle has at least one grounding contact member, whereat each contact of the memory card receptacle is in contact with a grounding contact member when there is no memory card inserted into the device.

The advantage is that any static discharge electric charges will have a controlled discharge path and the components of an electronic equipment device will be protected against expensive damages caused by high ESD charges.

The invention will now be described in more detail with reference to the enclosed drawings.

### SHORT DESCRIPTION OF DRAWINGS

FIG. 1 is a schematic view of an electronic equipment device 10 comprising a memory card receptacle.

FIG. 2 is a schematic top view revealing a memory card and a preferred embodiment of a memory card receptacle.

FIG. 3 is a schematic partial cross-sectional transverse view of the memory card device interior taken on the line A-A of FIG. 2.

FIG. 4 is a schematic top view of the memory card device.

FIG. 5 is a schematic partial cross-sectional transverse view of the memory card receptacle interior taken on the line B-B of FIG. 2 showing a front view of the preferred embodiment.

FIG. 6 is a schematic partial cross-sectional transverse view of the memory card device interior taken on the line A-A of FIG. 2 showing a side view of the preferred embodiment when a memory card is inserted into the memory card space.

FIG. 7 shows a top view of a second embodiment of the invention.

FIG. 8 is a schematic partial cross-sectional transverse view of the memory card device interior taken on the line D-D of FIG. 7 showing a side view of this second embodiment of the invention.

FIG. 9 is a schematic view of a mobile radio telecommunication system.

FIG. 10 is a schematic view of a detached portable mobile radio communication station according to the invention.

### PREFERRED EMBODIMENTS

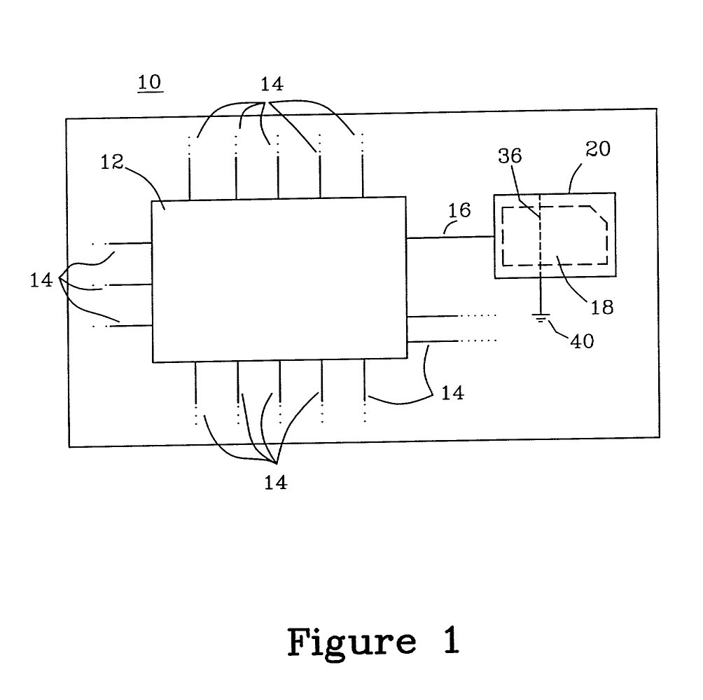

FIG. 1 is a schematic view of an electronic equipment device 10 comprising a memory card receptacle 20 and a control unit 12 that comprises at least one processor for controlling other units of the device. Said units are coupled to in-/out ports 14 of the control unit. The memory card receptacle 20 is an interface for connecting a memory card 18 to the control unit via a data bus 16. A user can insert the card into the receptacle 20 or take it out when appropriate. The receptacle 20 makes it possible for the control unit 12 to electrically read the information stored in the memory card 18.

For an example the electronic equipment device 10 could be a portable radio communication station in a mobile radio telecommunication system. In such a system the memory card 18 is identified as Subscriber Identification Module (SIM) and the memory card receptacle 20 as a SIM chip card reader. In the following the broader terms memory card 18 and memory card receptacle 20 will be used in the description, but said terms are regarded as equivalent to and therefore replaceable with the terms SIM card and SIM (chip) card reader respectively or corresponding terms in a mobile radio telecommunication system, as long as the function and design of the devices are identical.

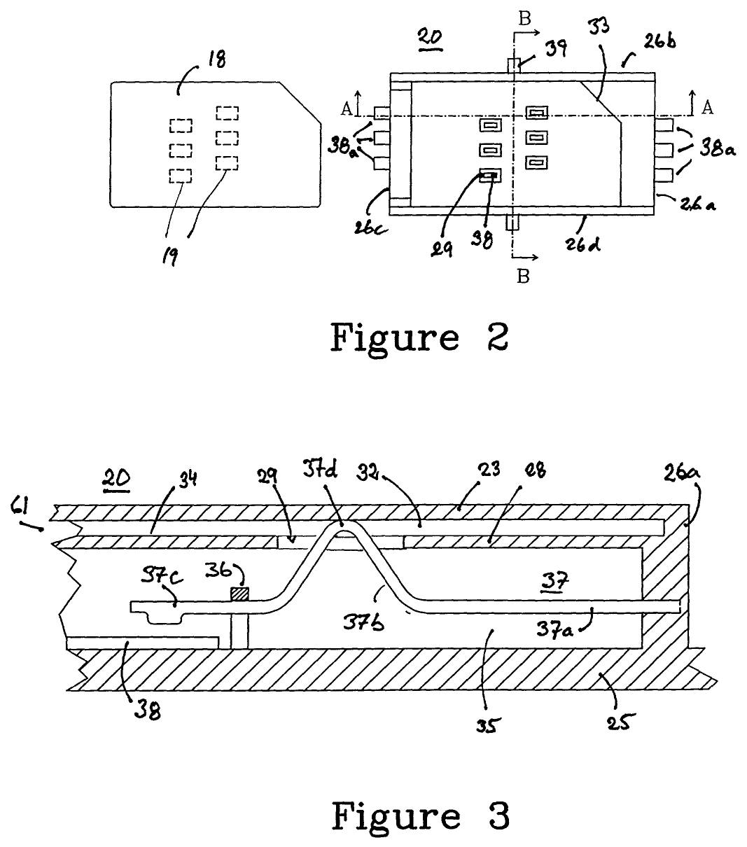

A preferred embodiment of the invention will now be described in more detail with references to FIGS. 2-6.

A top view revealing a memory card 18 and a preferred embodiment of a memory card receptacle 20 is shown in FIG. 2. The memory card has a number of electric contacts, memory card contacts 19. The device 20 is a construction comprising a top lid (not shown), four sidewalls 26a-d, a contact cover 28 and at least one contact 30. Each contact 30 is situated under the contact cover 28, which has recesses 29 for letting a part of each contact 30 to protrude through the contact cover 28 into a memory card space 32. This showed embodiment includes six contacts 30 protruding through the contact cover 28.

The memory card receptacle 20 has to have the same number of contacts 30 as the memory card 24 has memory card contacts 19 and the position of each contact 30 is determined by the position of corresponding memory card contact 19.

The combination of the top lid 23, the contact cover 28 and three of the sidewalls 26 forms the memory card space 32. The forth side wall 26 has a slot or opening see FIG. 10 enabling insertion and rejection of the memory card. The card space 32 includes a raised triangular shaped polarizer 33 disposed in one corner of the memory card space 32. The triangular shaped polarizer 33 insures that the memory card 24 has been inserted on the proper side and in the proper direction. The three walls 26 create a retention area 34 that is formed to the size and shape of the memory card 24, where the memory card 24 will rest when it has been properly aligned. The contacts 30 are properly electrically coupled to the memory card 24 when the card is aligned.

FIG. 3 is a schematic partial cross-sectional transverse view of the memory card device interior taken on the line A-A of FIG. 2 showing a side view of the preferred embodiment with one of its electrical contacts 30.

The memory card receptacle 20 can have an integrated base, a so called base cover 25, or be attached to a surface e.g. a surface of a printed circuit board (PCB) or another suitable construction detail of an electronic equipment 10. Such a surface or construction detail will serve as a base cover 25. There is a contact chamber 35 between the walls, the base cover 25 and the contact cover 28. Said contact chamber 35 contains the contacts 30 and at least one grounding contact member 36. This embodiment makes use of only one grounding contact member 36. However, in other embodiments more than one grounding contact member 36 can be used. For an example, in one embodiment each contact 30 can have it's own grounding contact member 36.

Each contact 30 comprises a movable contact member and signal contact member. In this embodiment the movable contact member comprise a bendable arm portion 37a, an extension portion 37c and a n-shaped portion 37b coupled in between the arm portion 37a and the extension portion 37b. One end of each contact member is fixed in one of the sidewalls 26a. An electrical conducting part of the contact, in this embodiment it is the extension portion 37, will rest at the grounding contact member 36 when the protruding n-shaped portion 37 not is in contact with the memory card. Each unloaded contact 30 extends parallel to each other and to the retention area 34. The bendable contact member 37a is coupled to a n-shaped portion 37b, with a curved part of the n-shaped portion protruding into the memory card space 32 between the top lid. 23 and the contact cover 28, thereby forming a contact portion 37d that easily slides against the surface of the memory card during the insertion or ejection of said card.

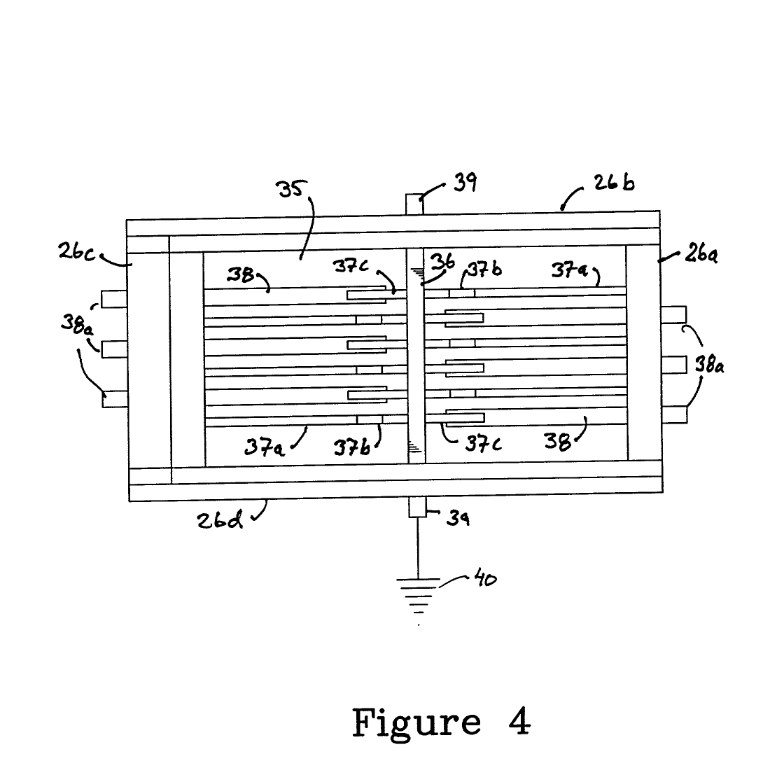

FIG. 4 is a schematic top view of the memory card device with both the top lid 23 and the contact cover 28 lifted of the device. Each of the six contacts comprise a bendable arm portion 37a, an extension portion 37c and a n-shaped portion 37b sitting in between the arm portion 37a and the extension portion 37c. Each movable arm 37 protrudes from opposite sidewalls 26a, 26c into the contact chamber 35. An electrical conducting part of the contact, in this embodiment the extension portion 37c, will rest at the grounding contact member 36 when the movable contact member 37 not is in contact with the memory card 18.

This embodiment has only one grounding contact member 36. It is located in the middle of the contact chamber 35, on equal distance from each of the sidewalls 26a, c where the contacts are fixed. The grounding contact member 36 is U-shaped and crosses all contacts 30 and protrude through at least one of the sidewalls 26b, 26d, which is parallel to the contacts 30(37,38), to the outside of the memory card receptacle 20. As disclosed in this embodiment the grounding contact member 38 protrudes through both said sidewalls 26b, 26d. At least one of the protruding parts, called grounding contact terminals 39, of the grounding contact member 36 shall be connected to the grounding shield 40 of the electronic equipment device 10. Said connection (by gluing, contacting, soldering etc.) to the grounding can easily be made by a person skilled in the art.

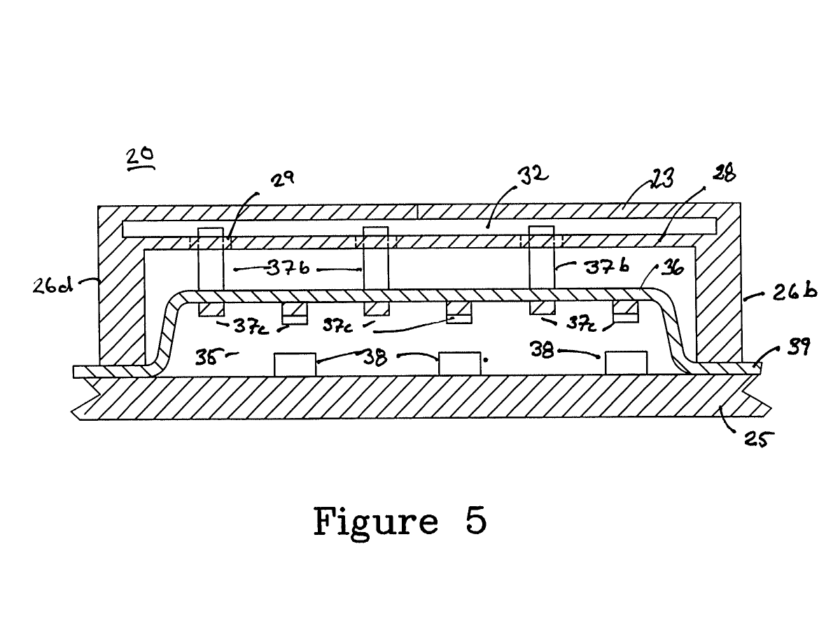

FIG. 5 is a schematic partial cross-sectional transverse view of the memory card receptacle 20 interior taken on the line B-B of FIG. 2 showing a front view of the preferred embodiment.

Said FIG. 5 discloses the top lid 23, the contact cover 28, the sidewalls 26b, d, the six contacts 37c and the grounding contact member. The n-shaped portion of the movable contact member is protruding into the memory card retention space 32 through the recesses 29 of the contact cover 28. An electrical conducting part of the contact, in this embodiment it is the extension portion 37c, will rest at the grounding contact member 36 when the n-shaped portion 37b not is in contact with a memory card.

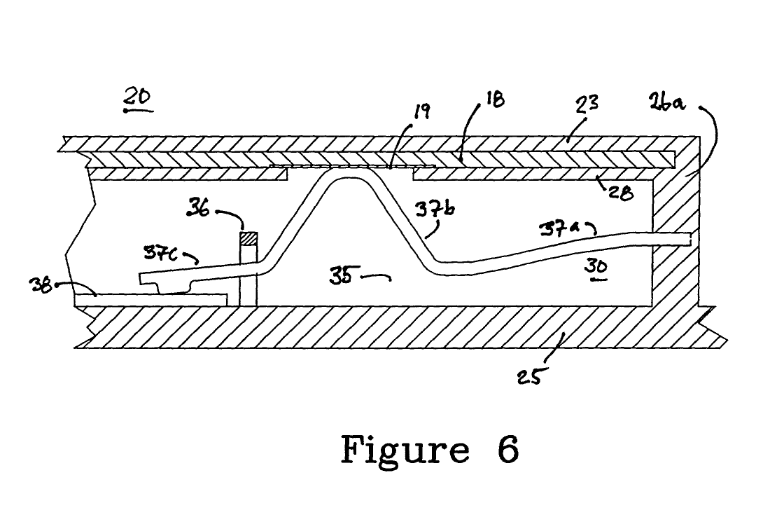

FIG. 6 is a schematic partial cross-sectional transverse view of the memory card device 20 interior taken on the line A-A of FIG. 2 (compare with FIG. 3) showing a side view of the preferred embodiment when a memory card 18 is inserted into the memory card space 32. The memory card 18 will force the n-shaped portion 37b in the direction towards the base cover 25. The extension portion 37c of the movable contact member 37 will be pushed from the grounding contact member 36 and its first protected position into contact with the signal contact member 38 and thereby a second signal conducting position of the movable contact member 37. The signal contact member 38 continue from the contact chamber 35 through one of the sidewalls 26a to the outer side of the device housing and ends in a grounding contact terminal 39. Other electronic components(e.g. a control unit) or a PCB of the electronic equipment device 10 is fixed by known methods to each terminal 38a of the signal contact member 38. The information stored within the memory card 18 is than accessible for use. When the memory card 18 is taken out of the receptacle device 20 the movable contact member 37 returns to its first position where the movable member 37 is unloaded.

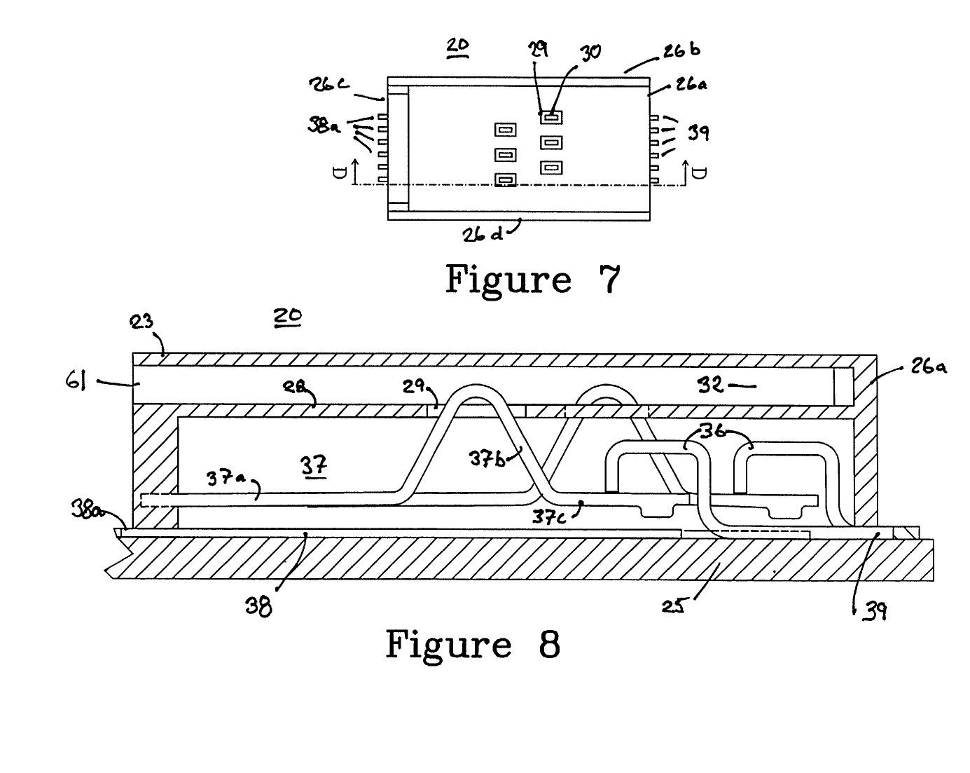

Another embodiment of the invention will now be described with reference to FIGS. 7 and 8.

A top view revealing a memory card receptacle 20 is shown in FIG. 7 and FIG. 8 is a schematic partial cross-sectional transverse view of the memory card device 20 interior taken on the line D-D of FIG. 7 showing a side view of this second embodiment of the invention.

This embodiment is in most details identical to the previous embodiment described in FIGS. 2 and 3. This embodiment differs from the previous one only in that it has separate grounding contact members 36 for each of the movable contact members 37. Each one of the movable contact members 37 has a corresponding grounding contact member 36. A memory card receptacle 20 according to this embodiment has the same number of grounding contact terminals 39 as signal contact terminals on the outside of the housing as shown in FIG. 7. It is favourable to have the grounding contact terminals 39 separated from the signal contact terminals 38a by having them located on different sides of the receptacle housing. All movable contact members 37 will be fixed to one of the sidewalls 26a as shown in FIG. 8. This embodiment has the advantage that a designer of electronic equipment devices can choose which of the contacts he wants to ESD protect if it isn't necessary to ESD protect all contacts as it is done in the first described embodiment.

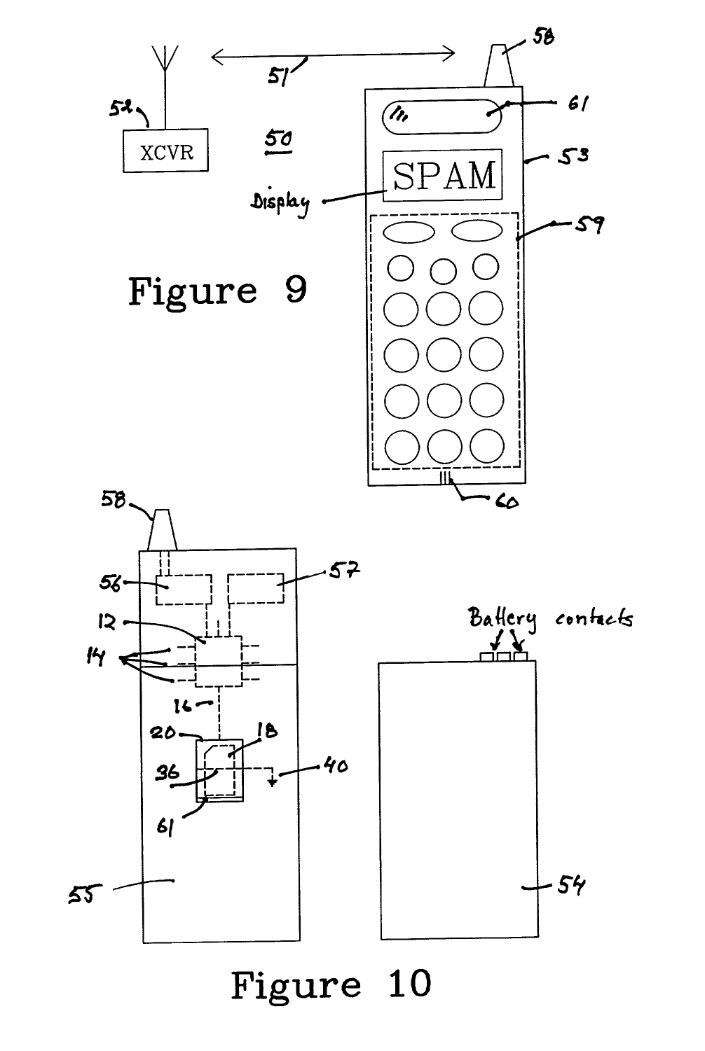

A mobile radio telecommunication system 50, as shown in FIGS. 9 and 10, transmits information signals 51 between a fixed site transceiver 52 and a portable radio mobile communication station 53. The portable radio station 53 comprises a battery portion 54 and radio portion 55 including a control unit 12, a transceiver 56, a user interface module 57 and an antenna 58. The transceiver 56 is responsible for receiving and transmitting the signal 51 between the fixed site transceiver and itself. It is also responsible for verifying the subscriber's identification for billing purposes. The battery portion 54 is a detachable rechargeable power source used to power the electronics contained in the portable radio station. The antenna 58 transmits signals 51 to and receives signals 51 from a fixed site transceiver 52. The user interface module 57 contains a keypad 59, a display 62, a mouthpiece 60 and an ear piece 61. The memory card receptacle 20 is placed between the battery portion 54 and the radio portion 55 in this embodiment to protect the memory card receptacle 20 from the external environment. A slot or opening 61 enables a user to insert and eject the memory card 18.

The memory card receptacle 20 comprises at least one contact for electrically contacting a memory card 18. Said memory card receptacle 20 has at least one grounding contact member 36 for protecting electronic equipment 10 against Electro Static Discharge (ESD). Each contact 30 is in contact with a grounding contact member 36 when there is no memory card 18 in the device 20.

The memory card receptacle 20 is in this embodiment a SIM chip card reader 20 comprising at least one contact 30 for electrically contacting said SIM card 18 (Subscriber Identification Module). Said card reader 20 has at least one grounding contact member 36 for protecting electronic components of the portable radio terminal 53 against Electro Static Discharge (ESD), whereat at least one contact 30 is in contact with a grounding contact member 36 when there is no SIM card 18 in the card reader 20.

The SIM chip card reader 20 is used as an interface providing electrical connections between a SIM chip card 18 containing subscriber information and electronics internal to the portable transceiver 53. The SIM chip card 18 must be aligned within the SIM chip card reader 20 in order to obtain the information from the SIM chip card 18. The SIM chip card 18 is aligned with the sliding contacts contained within the SIM chip card chamber when the SIM chip card is slid into the opening 61 of the SIM chip card chamber 32, into the retention area 34. Here, the SIM chip card 18 will be retained until it is ejected by the user. The SIM chip card 18 is retained by a combination of the retention area 34 and the force of the sliding contacts 30. Once the SIM chip card 18 is retained in this position, the contacts 30 are coupled to the SIM chip card contacts 19, allowing the portable transceiver 54 access to the information stored within the SIM chip card 18. The electrical operation of the SIM chip card 18 is described in International Standards Organisation (ISO) Document #7816-3: 1988 (E), Technical Committee ISO/TC 97, Information Processing Systems, May 15, 1988 (First Edition).

The Invention is of course not limited to the above described and in the drawings disclosed embodiments but could be modified within the scope of the enclosed claims.

1. A memory card receptacle (20) comprising at least one contact (30) (37,38) for electrically contacting a memory card (18), characterised in that, said device has at least one grounding contact member (36) for protecting electronic equipment (10) against electro static discharge (ESD), whereat at least one contact (30) is in contact with said grounding contact member (36) when the memory card (18) not is inserted in the memory card receptacle (20).

2. A memory card receptacle (20) according to claim 1, characterised in that, the receptacle (20) comprises equal number of grounding contact members (36) as contacts (30).

3. A memory card receptacle (20) according to claim 1, characterised in that, the grounding contact member (36) crosses all contacts (30).

4. A memory card receptacle (20) according to claim 3, characterised in that, the grounding contact member (36) is U-shaped.

5. A memory card receptacle (20) according to claim 2 or 4, characterised in that, a contact (30) comprises a movable contact member (37) and a signal contact member (38).

6. A memory card receptacle (20) according to any of the preceding claims 1-5, characterised in that, the memory card (18) is a SIM module chip card and the memory card receptacle (20) is a SIM module chip card reader.

7. A portable radio communication station (53) having a SIM chip card reader (20) comprising at least one contact (30) for electrically contacting said SIM card (Subscriber Identification Module) (18), characterised in that, said card reader (20) has at least one grounding contact member (36) for protecting electronic components of the portable radio station against Electro Static Discharge (ESD), whereat at least one contact (30) is in contact with a grounding contact member (36) when the memory card (18) is missing in the SIM chip card reader (20).

8. A portable radio communication station according to claim 7, characterised in that, the receptacle 20 comprises equal number of grounding contact members (36) as contacts (30).

9. A portable radio communication station according to claim 7, characterised in that, the grounding contact member (36) crosses all contacts (30).

10. A portable radio communication station according to claim 9, characterised in that, the grounding contact member (36) is U-shaped.

11. A portable radio communication station according to claim 8 or 10, characterised in that, a contact (30) comprises a movable contact member (37) and a signal contact member (38).

12. An electronic equipment device (10) having a memory card receptacle (20) comprising at least one contact (30) for electrically contacting said memory card (18), characterised in that, said memory card receptacle (20) has at least one grounding contact member (36) for protecting against Electro Static Discharge (ESD), whereat at least one contact is in contact with a grounding contact member (36) when a memory card (18) is missing in the a memory card receptacle (20).

13. An electronic equipment device (10) according to claim 12, characterised in that, the receptacle 20 comprises equal number of grounding contact members (36) as contacts (30).

14. An electronic equipment device (10) according to claim 12, characterised in that, the grounding contact member (36) crosses all contacts (30).

15. An electronic equipment device (10) according to claim 14, characterised in that, the grounding contact member (36) is U-shaped.

16. An electronic equipment device (10) according to claim 13 or 14, characterised in that, a contact (30) comprises a movable contact member (37) and a signal contact member (38).
